(19) United States
(12) Patent Application Publication
(10) Pub. No.: US 2012/0265871 A1
(43) Pub. Date: Oct. 18, 2012

(54) MULTICAST, CLIENT/SERVICE-ATTRIBUTE RESOLUTION

(75) Inventor: Craig M. Dowell, Bellevue, WA (US)

(73) Assignee: QUALCOMM INNOVATION CENTER, INC., San Diego, CA (US)

(21) Appl. No.: 13/089,082

(22) Filed: Apr. 18, 2011

(51) Int. Cl. G06F 15/16

(52) U.S. Cl. 709/224

(57) ABSTRACT

Proximity-based communications is established between client and service applications mediated by bus daemons. Client applications consume services and service applications provide services. A unique discovery protocol provides a name service in the bus daemon structure to assist the bus daemons in discovering the service applications available at other bus daemons. Bus daemons periodically announce their existence and provide the address and port over which they may be contacted. They also provide attribute information consisting of a description, such as an instance attribute and a well-known name attribute, of the service applications available at the bus daemon. The name service in the bus daemon structure may also respond to queries as to the availability of requested service applications. When client applications require access to a service application, they query their associated bus daemon that, in turn, queries its name service.

### BACKGROUND

1. Field of the Invention

This invention relates to multicast, client/service-attribute resolution. More particularly the invention relates to discovering client applications and server applications having particular attributes and being located on multiple computing systems in an IP multicast group of computing systems.

2. Background of the Invention

When there are multiple computers on a network, and there is no common system administrator with access to all of those computers, the computers must find devices on the network using some discovery process. Classically, a system administrator or a system network can monitor the network and say, for example, the network includes “Bob's Printer” which can be found at “IP address” and the printer supports “name” protocols. However in a wireless network, for example, each user has his own computing system, and there is no common system administrator in the network. The computer must discover “name” devices on the network for itself.

There are currently extensions to the domain name service (DNS) which extensions are multicast domain name service (mDNS). One implementation is “Bonjour” service by Apple Computer Incorporated, which is used with the iTunes application program among others. Another implementation is Avahi service that is an mDNS service for Linux operating systems. The idea of these extensions to the domain name service is to allow computers to send out information about what services they support and to ask for information about what services other computers on the network support.

In using mDNS there are two sides to a conversation: a requester and a responder. A requester asks other mDNS participants whether or not they support a particular service type, encoded as for example a “proto” protocol. A responder on each participant answers queries and would say, for example, I am named “Joe's phone” and I support the “proto” protocol. If more than one participant supports the “proto” protocol, multiple answers may be received by the requester. Typically the requester then decides which of the answers it is interested in and then performs a separate step to resolve the name “Joe's phone” and the protocol “proto” into an IP address and port over which the desired service can be reached. Attributes of the service may also be found during the resolve phase of the conversation and indicate for example characteristics of specific instance of the service.

In peer-to-peer communications, where multiple users wish to interact as in playing a game, for example, mDNS can be used to link all the users into the same game. However, using mDNS to do this is very cumbersome. The computers desiring to participate in the game must all export the fact that they support the protocol used to establish the game and all devices must query for all other devices on the network that support the game establishment protocol. In order to contact each other, the separate step of resolving the returned names must be performed for every participant and any attributes of the individual participants must be resolved. There is a large amount of network and internal state overhead to track and keep consistent the “name” computers, computers that have the “game” protocols, and computers currently playing the game particularly as players enter and leave the game. To use mDNS to support such a game scenario, the network must either handle a large number of queries or it must store a large amount of network state information.

It is with respect to these considerations and others that the present invention has been made.

### SUMMARY OF THE INVENTION

In accordance with the present invention, proximity-based communications is established between client and service applications mediated by bus daemons. Client applications consume services and service applications provide services. A unique discovery protocol provides a name service in the bus daemon structure to assist the bus daemons in discovering the service applications available at other bus daemons. Bus daemons periodically announce their existence and provide the address and port over which they may be contacted. They also provide attribute information consisting of a description, such as an instance attribute and a well-known name attribute, of the service applications available at the bus daemon. The name service in the bus daemon structure may also respond to queries as to the availability of requested service applications. When client applications require access to a service application, they query their associated bus daemon that, in turn, queries its name service. When other bus daemons are discovered having access to a requested service application, the requesting client application may arrange that the bus daemons exchange information in a manner that allows a location independent connection to be made between the client application and service application.

In accordance with other aspects, the present invention relates to an apparatus for discovering service applications available for communication through daemons in computing systems in a multicast group of computing systems. A daemon module in a computing system in the multicast group responds to discovery requests from its client applications and its service applications by initiating multicasts of attribute information for client applications and service applications. The attribute information for each client application and service application has at least a well-known-name attribute in the attribute information description of each application. A name service module in the computing system associated with the daemon module responds to a discovery request by initiating a discovery operation request. A responder module in the computing system associated with the name service module responds to the discovery operation request by sending a discovery message to the multicast group. The discovery message has attribute information with a given well-known-name of a service application making the discovery request at the computing system. Also, responder module responds to a first type discovery message from a computing system in the multicast group, the first type discovery message asking for any instance of a named service application with a well-known-name attribute matching one specified by a client application making a discovery request. If the computing system has such an instance of the named service application, the responder module sends a second type discovery message identifying the instance of the named service application with the well-known-name attribute at the computing system. Also, the responder module responds to a second type discovery message from a computing system in the multicast group. The second type discovery message announces an instance attribute and a well-known-name attribute for a service application at the computing system in the multicast group. The responder module notifies the daemon module of the availability of an instance of the service application with the well-known-name attribute at the computing system in the multicast group.

In accordance with still other aspects, the present invention relates to a method for discovering service applications available for communication through a home bus daemon in the user's computing system or through the home bus daemon and a remote bus daemon in a remote computing system of a multicast group of computing systems. In response to a request from a service application available at the home bus daemon, an initiating operation initiates an advertise operation request from the home bus daemon. In response to an advertise operation request, an advertise message is multicast to the multicast group of computing systems. The advertise message has attribute information with an instance identifier and a well-known-name attribute of the service application at the user's computing system and an address of the home bus daemon through which the service application is available. In response to an advertise message from a remote bus daemon, the home bus daemon is notified of the availability of an instance of a service application with the well-known-name attribute at the remote bus daemon.

In response to a discovery request from a client application at the user's computing system, an initiating operation initiates a find-name operation request from the home bus daemon. In response to a find-name operation request, a query message is multicast to the multicast group of computing systems from the home bus daemon, the query message asks for any service application having a well-known-name attribute that matches the name prefix attribute provided in the query message. In response to a query message, a detecting operation detects whether the home bus daemon has the service application that matches the well-known-name prefix attribute in the query message. The detecting operation sends an advertise message if an instance of the service application with the matching well-known-name attribute is available through the home bus daemon at the user's computing system.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Some advantages of the invention are the efficiency and speed with which client applications and service applications wishing to communicate with each other may discover each other. Another advantage of the invention is the ease with which client applications and service applications may enter or leave a group of applications that are communicating with each other.

### BRIEF DESCRIPTION OF THE DRAWINGS

FIG. 1 shows a plurality of mobile computing systems communicating over a wireless network.

FIG. 2 illustrates an exemplary computing system.

FIG. 3 illustrates an architecture used by two computing systems to discover and link peer-to-peer client and server applications through bus daemons in each computing system.

FIG. 4 illustrates a typical conversation between bus daemons such as those in FIG. 3 during the operation flow for discovering bus daemons having access to service applications.

FIG. 5 shows the operation flow of a bus daemon and its name service acting in response to an ADVERTISE request from a service application.

FIG. 6 shows the operation flow of a bus daemon and its name service acting in response to an FIND-NAME request from a client application.

FIG. 7 illustrates the operation flow of a responder in a name service in response to operation requests. User Datagram Protocol packets, and timer events.

FIG. 8 illustrates the operation flow of a bus daemon notifying interested client applications that a service application with a well-known-name attribute has been found.

### DESCRIPTION OF PREFERRED EMBODIMENTS

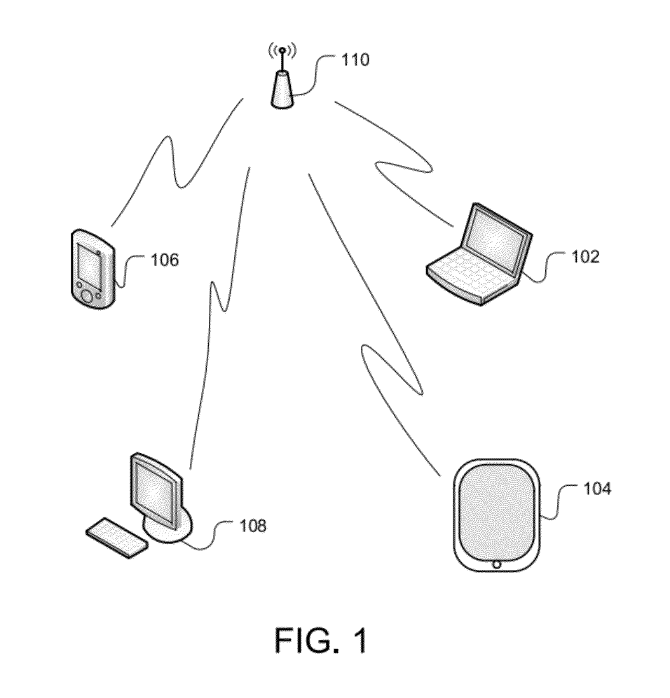

FIG. 1 shows four computing systems—a laptop computer 102, a tablet computer 104, a smart phone 106, and a desktop computer 108—communicating over a wireless network using access point 110. Laptop computer 102 or desktop computer 108 might be running the Windows (trademark of Microsoft Corporation) operating system or a Linux operating system. Each computing system wishing to participate in service discovery uses a name service to send UDP (User Datagram Protocol) messages to a predefined multicast group IP (internet protocol) address.

To advertise the availability of a service application at a computing system, its bus daemon sends an advertise request to the name service. In response, the name service sends a UDP message to the multicast IP address. This UDP message includes a GUID (globally unique identifier) for the sending computing system's bus daemon, and the bus daemon's address (IPADDRESS,PORT). The UDP message also includes a list of names of service applications available through the bus daemon at the sending computing system including the newly advertised service application. In effect the sending bus daemon announces:

a. “I have <org.example.Well-Known-Name.Instance> service application.”

The “Well-Known-Name” attribute is typically the name of the program implemented by the service and client applications, but it may be an abbreviation, an acronym or any identifier for the program. The “Instance” attribute identifies an instance of the service application with the well-known-name attribute that is running on its computing system. Other instances of the service application with the well-known-name attribute at the same bus daemon or another bus daemon in the multicast group may be advertised at the same time. Each instance must have a unique identifier that might be established by the service application when it becomes active. Some possible examples of unique identifiers for an instance might be a unique number, a time stamp, user ID, player name or number, computer ID, bus daemon GUID, etc.

For example, the user on a smart phone or laptop computer might want to play a multiplayer game with the well-known-name, SeaAdventure. The multiplayer game may be implemented as a service application to allow other instances of the game to communicate with the local instance of the game, but may also act as a client application to allow the local instance of the game to communicate with other remote instances. The local instance will have to advertise the existence of the local service application, but also discover remote instances of game's service application. This is done via two UDP messages sent by the name service to the multicast IP address. The first UDP message, an advertise message, would tell the bus daemon at every other computing system participating in the logical bus by listening at the multicast IP address that bus daemon GUID (global unique identifier) at IPADDRESS,PORT in the multicast group has available SeaAdventure.Player001, i.e. instance Player001 of SeaAdventure, game's service application. Of course the system could send multiple UDP messages, one per instance of a game, social media application, or other type of service application. Alternatively the system could send a list of instances of games, social media, or other type of service applications that the service application's sending bus daemon wishes to advertise.

This advertise UDP message is referred to as an IS-AT message. In FIG. 1 if a UDP IS-AT message for SeaAdventureplayer001 game instance originates at laptop computer 102, it is sent to the well-known IP multicast group. In the case of infrastructure mode IEEE 802.11 the packet is first sent to access point 110 and is then retransmitted to be received by laptop computer 102, tablet computer 104, smart phone 106 and desktop computer 108. Each computer in this multicast group, if listening to the multicast IP address for the multicast group of the name service would know that a bus daemon at a known address has instance player001 of SeaAdventure game's service application. If a client exists on one of those computers that is interested in playing SeaAdventure game, it could connect to laptop computer 102. This connect operation with laptop computer 102 creates the desired symmetrical arrangement of client and service applications.

In another multi-player example, a user of laptop computer 102 enters a wireless network where other users of computing systems are already playing SeaAdventure game. The user will start a client application that will ask the bus daemon in the user's computer to locate instances of SeaAdventure game service applications. The bus daemon will ask the name service to discover those instances, and the name service will send out a UDP WHO-HAS message. This UDP WHO-HAS message is a query message asking:

“Who has <org.example.SeaAdventure.*> service application?”

The wild card asterisk(*) for the instance attribute indicates any instance of the service application with the well-known-name attribute, SeaAdventure, is being sought. The bus daemon of any computing system in the multicast group laptop computer 102, tablet computer 104, smart phone 106 and desktop computer 108—that has an instance of the service application for SeaAdventure game, i.e. a user is currently playing the SeaAdventure game, would reply with an IS-AT message. The message contains the GUID (global unique identifier), IPADDRESS,PORT of the replying bus daemon and a string indicating that SeaAdventure game is available there.

For example, if a user on smart phone 106 is playing SeaAdventure game, the name service on smart phone 106 replies with a UDP IS-AT message containing GUID and address of bus daemon of smart phone 106 and the message in effect saying, “I have Instance, Player001 of service application with well-known-name attribute SeaAdventure.” When the name service of laptop computer 102 receives the UDP IS-AT message, it indicates to its bus daemon that it has discovered a remote bus daemon that is advertising the fact that it has an active SeaAdventure game service application. The bus daemon, in turn, notifies its local client application. The client application can then decide to use the remote, advertised service application and ask the local bus daemon to connect to the remote bus daemon. This logical connection of bus daemons causes information to be exchanged between the bus daemons and that information enables remote procedure calls between the client and service applications. In the case where the SeaAdventure game application consists of both client and a service application part, the symmetric case allows bi-directional communication between the game instances.

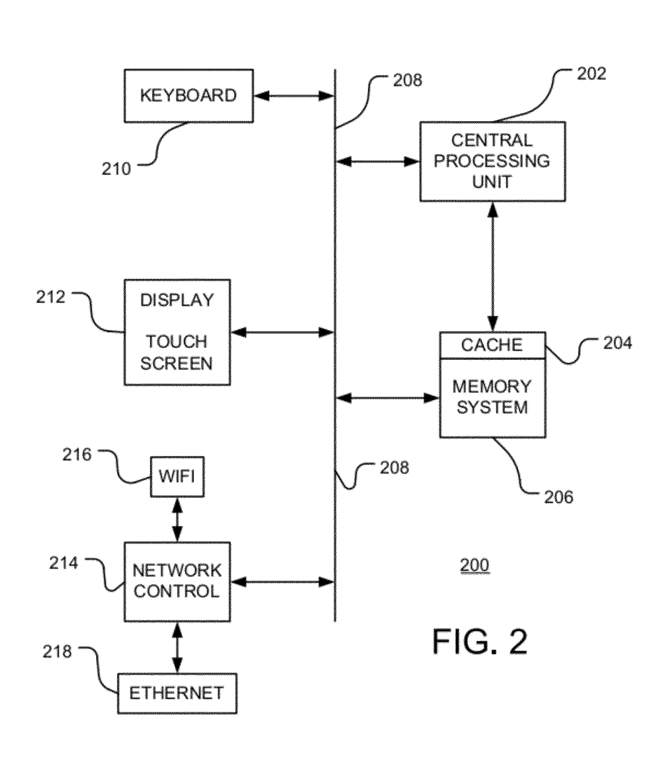

FIG. 2 is an exemplary computing system 200 representative of any type of computer, laptop computer, tablet computer, smart phone, desk top computer, or intelligent computing device that might be used to participate in a logical bus. Central processing unit (CPU) 202 is the main processing unit executing computer processes. CPU works with cache memory 204 in memory system 206 as well as program storage, file storage and working storage also contained in memory system 206. Cache memory is usually directly linked to CPU 202, while remaining storage in the memory system may be accessed through bus 208.

Keyboard module 210 is one input device available to CPU 202 through bus 208. Another input device is a touch screen in display 211. Display 212 with its touch screen serves as both an output device displaying information to a user and an input device receiving input from the user via the touch screen. Display 212 is connected to CPU 202 over bus 208.

Network control module 214 connects to CPU 202 to perform network control operations to connect the system to a wireless network via WIFI transceiver 216 or to a hardwired network through Ethernet adapter 218. Network control module may be an intelligent module with its own computing system and memory including cache. Alternatively, it may be implemented as firmware or software running on CPU 202. Likewise the keyboard 210, display 212 memory system 206 may all be intelligent subsystems communicating over bus 208. One skilled in the art is well aware of the many variations possible in the design of a computing system performing the logical operations of the various embodiments of the present invention.

Computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD), magnetic cassettes, magnetic tape, magnetic disk storage or other magnetic storage devices, or other optical storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as an optical fiber network, a wired network or direct-wired connection, and wireless media such as acoustic, RF, infrared, and other wireless media. Combinations of any of the above should also be included within the scope of computer-readable media. Computer-readable media may also be referred to as computer program product.

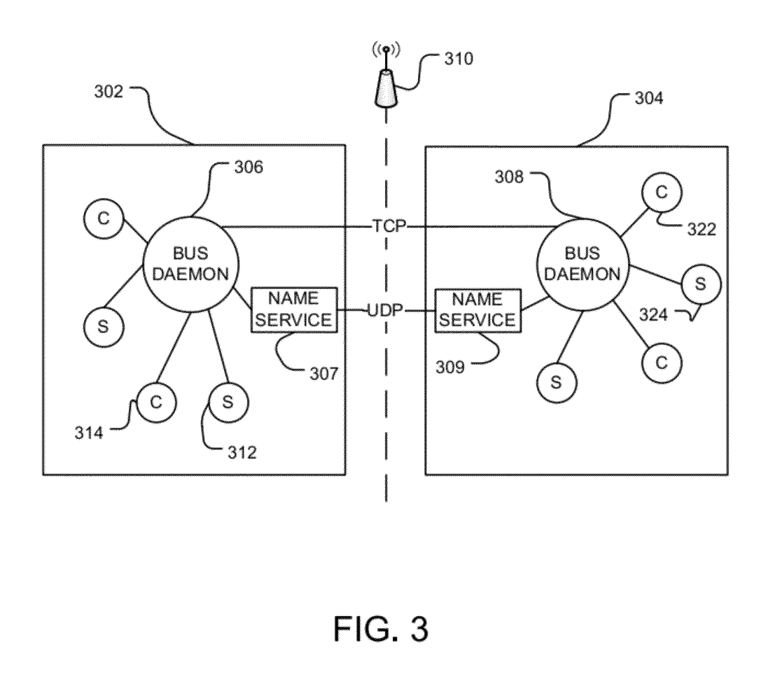

FIG. 3 illustrates two computing systems 302 and 304 in a logical bus consisting of two bus daemons with their associated client and service applications. The computing systems are in a multicast group such as the group shown in FIG. 1. Client applications in the computing systems discover service applications during a discovery phase. After client applications have discovered service applications and asked the bus daemons to connect, they may pass remote procedure calls and replies between their clients and servers using TCP messages orchestrated by the bus daemons. Name service module 307 works with bus daemon 306 to send UDP advertisement messages from name service 307 in response to discovery requests by bus daemon 306 during the discovery phase. Likewise name service module 309 works with bus daemon 308 to send the UDP advertisement messages from name service 309, in response to discovery requests by bus daemon 308 during the discovery phase. If, as a result of discovery messages, a client application on either computing system decides it wants to use a service application on the other computing system, it will ask the bus daemons to connect and exchange information. After the bus daemons have exchanged information and established peer-to-peer communications, the bus daemons are said to be joined. Now client applications in one computing system 302 or 304 may pass remote procedure calls to server applications in the other computing system, or vice versa.

Each application program using a logical bus has a client application, a server application or a combination thereof to communicate with its local bus daemon and thereby communicate with other service applications in other computing systems. For example, a SeaAdventure game, application program in computing system 302 has a client application part 314 and service application part 312, while another instance of the SeaAdventure game, application program in computing system 304 has client application part 322 and service application part 324. Once the bus daemons 306 and 308 are joined, the sense of client or service application is unimportant. The client and service distinction is important only in the service discovery phase to indicate what system is requesting and what system is responding. Once the busses are joined, the client and service applications at computing system 302 or 304 can be viewed as a merged client/service application, or in this case a SeaAdventure game, application. Now if either client application 314 or service application 312 wishes to execute a remote procedure call at service application 324 or client application 322, and if bus daemon 306 is joined with bus daemon 308, bus daemon 306 will build a TCP message to pass the remote procedure call to bus daemon 308. Bus daemon 308 in turn passes the procedure call to the desired client or service application 322 or 324. Any return information is processed in an inverse fashion. Likewise if client application 322 or service application 324 in computing system 304 wishes to execute a remote procedure call at client application 314 or service application 312 in computing system 302, bus daemon 308 will build a TCP message to pass the remote procedure call to bus daemon 306. Bus daemon 306 in turn passes the procedure call to service application 312 or client application 314. Return information is processed in an inverse fashion.

If bus daemons 306 and 308 have not joined when the mobile computing systems come with wireless range of each other, and an instance of the SeaAdventure game, service application 312 is running at computing system 302 with the bus daemon 306, the name service 307 periodically advertises the availability of the instance of SeaAdventure game, service application by multicasting a UDP Advertise message effectively announcing, “I have an instance of a service application with well-known-name attribute, SeaAdventure.” The UDP message with the GUID, IP ADDRESS, PORT for bus daemon 306 along with the well-known-name attribute and instance attribute of the service application 312 is multicast to all bus daemons of the computing systems within range of access point 310 at a local wireless network in a coffee shop, for example. The UDP message from name service 307 is received by all name services within range of the access point 310 that are monitoring the multicast address. Particularly, name service module 309 now knows that service application 312 for SeaAdventure game is available through bus daemon 306 in computing system 302.

Likewise, if a an instance of SeaAdventure game, service application 324 is running at computing system 304 with the bus daemon 308, the name service 309 periodically advertises the availability of SeaAdventure game, service application by multicasting a UDP message effectively saying, “I have an instance of a service application with well-known-name attribute, SeaAdventure.” The UDP message with the GUID, IP ADDRESS, PORT for bus daemon 308 along with the well-known-name attribute and instance attribute of the service application 324 is multicast to all bus daemons of the mobile computing systems within range of access point 310. The UDP message from name service 309 is received by all name services within range of the access point 310 that are monitoring the multicast IP address. Name service module 307 now knows that service application 324 for SeaAdventure game is available through bus daemon 308 in computing system 304. Either client application (314 or 322) may ask their respective bus daemons to connect to the other in which case the bus daemons are joined into a logical bus.

The client and server application nomenclature is symmetrical. Both client and server application parts of an application such as SeaAdventure game in this example are part of the same program running on different computing systems. Once the discovery phase is complete, and the bus daemons are joined, the client and server applications in a steady-state phase of operation are linked to each other and their remote procedure calls and replies flow through the bus daemons between the separate computing systems.

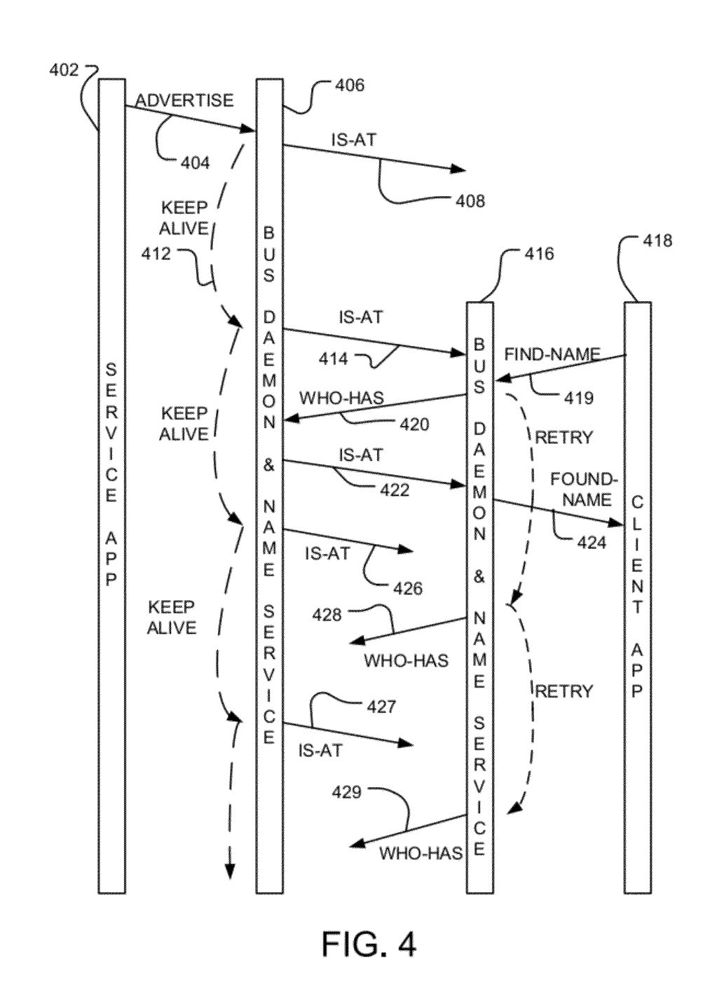

FIG. 4 illustrates a typical conversation between bus daemons such as those in FIG. 3 during the operation flow for discovering bus daemons having access to service applications with a well-known-name attribute. This discovery conversation is initiated by a service application 402 sending an ADVERTISE request 404 to bus daemon 406 requesting the bus daemon to advertise the availability of a Well-Known-Name service application. This happens when an instance of the Well-Known-Name service application has just attached itself to the bus daemon. Bus daemon 406 with its name service module builds the UDP IS-AT message and multicasts message instance 408 of the IS-AT message to the multicast group. The UDP message includes a KEEP ALIVE timer count. Bus daemon 406 also decrements the timer count to establish KEEP ALIVE interval. Whenever the KEEP ALIVE interval is decremented to a configurable value, the name service at bus daemon 406 will re-advertise the service application by generating new IS-AT messages, for example message instances 414, 426 and 427. This periodic re-advertisement happens as long as service application 402 is attached to the bus daemon 406 and allows bus daemons that have missed prior advertisements to receive them, or bus daemons newly arrived on a network segment to likewise receive them. If the service application 402 closes, the KEEP ALIVE timer count is set to zero, and bus daemon 406 no longer multicasts IS-AT message for service application 402. Accordingly, service application 402 can enter or leave participation in the Well-Known-Name application.

In FIG. 4, bus daemon 416 arrives in the local proximity and has a client application 418 that is interested in connecting to an instance of a service application with a well-known-name attribute. Client application 418 asks its bus daemon 416 to discover any instances of service applications having the Well-Known-Name. Name service module of the bus daemon 416 sends instance 420 of a WHO-HAS message. If service application 402 is active and has the Well-Known-Name attribute, name service module of bus daemon 406 constructs an IS-AT message indicating that an instance of a service application with the Well-Known-Name attribute is at bus daemon 406. The name service of bus daemon 406 sends a packet of instance 422 of the IS-AT message to the multicast group IP address.

Bus daemon 416 receives the IS-AT message from the name service component of bus daemon 406. The Well-Known-Name is entered in the cache of names and bus daemon addresses at bus daemon 416. The availability of service application 402 is communicated to client application 418 via FOUND-NAME message instance 424. The discovery phase is completed. If client application 418 chooses to ask the daemons to connect, service application 402 and client application 418 will be able to send remote procedure calls and procedure results using TCP messages. Bus daemon 406 will continue to periodically multicast IS-AT messages according to the KEEP ALIVE interval with renewed timer counts to advise other bus daemons of the instance of the Well-Known-Name service application 402. The TCP communication between bus daemons may be ended by one of the bus daemons sending a FIN message under control of either the client or service application. If service application 402 should close, this fact is advertised by sending an IS-AT message with a zero timer count. In this way, client applications and service applications may enter or leave participation in a well-known-name program at will without disrupting the operation of the program.

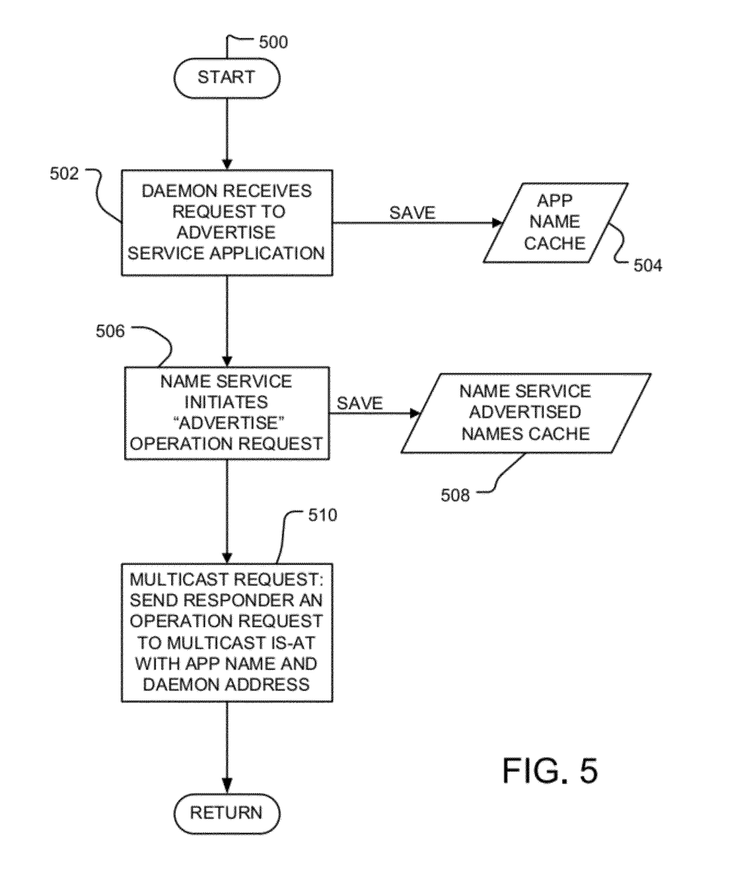

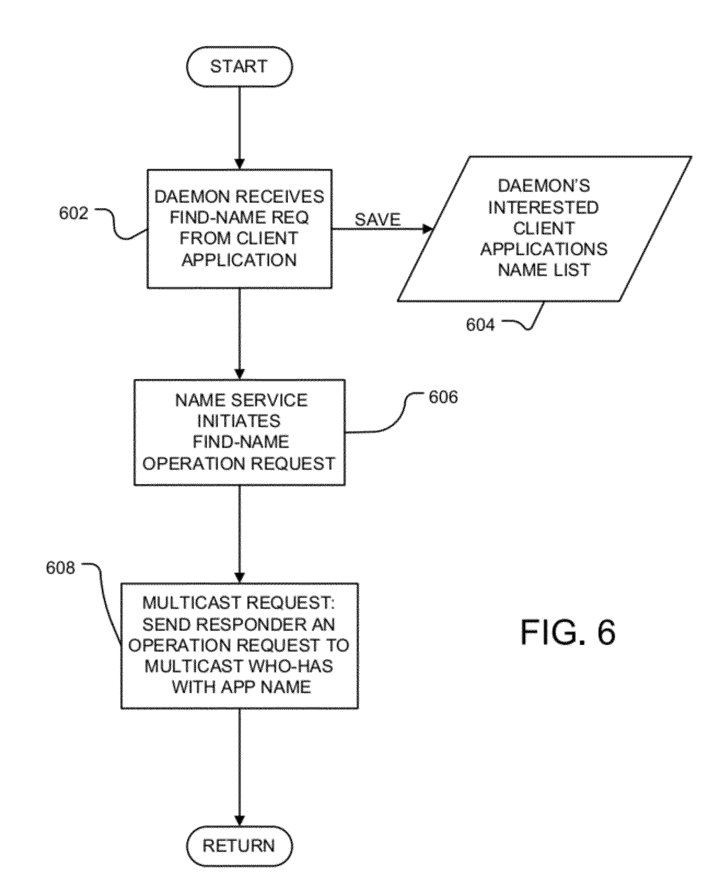

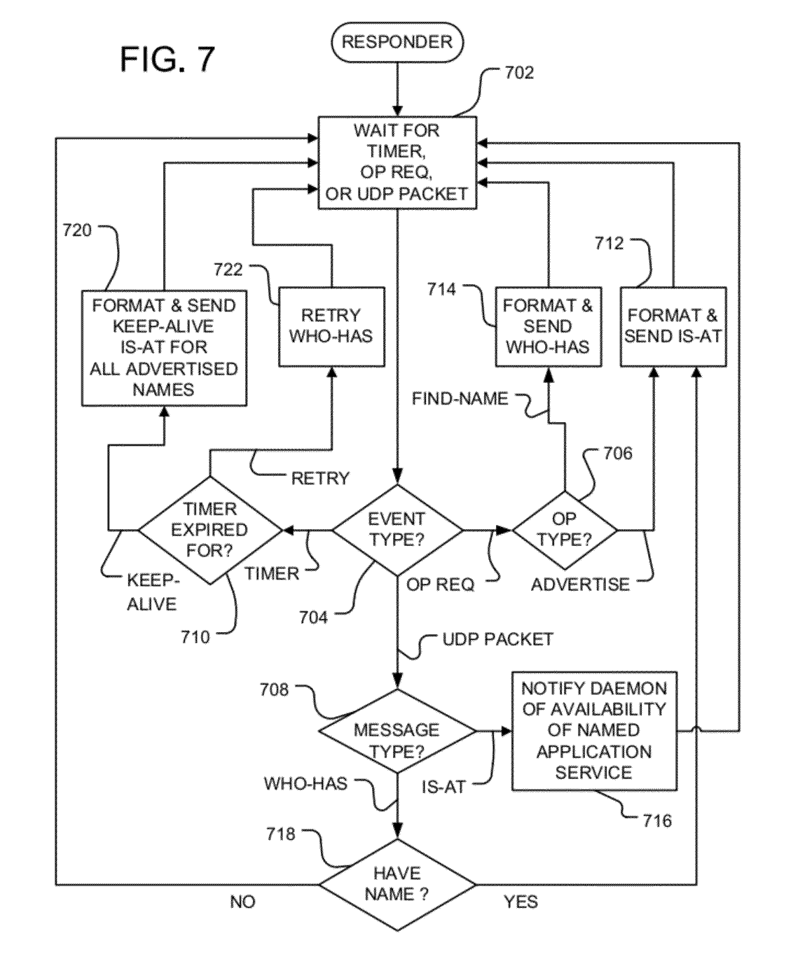

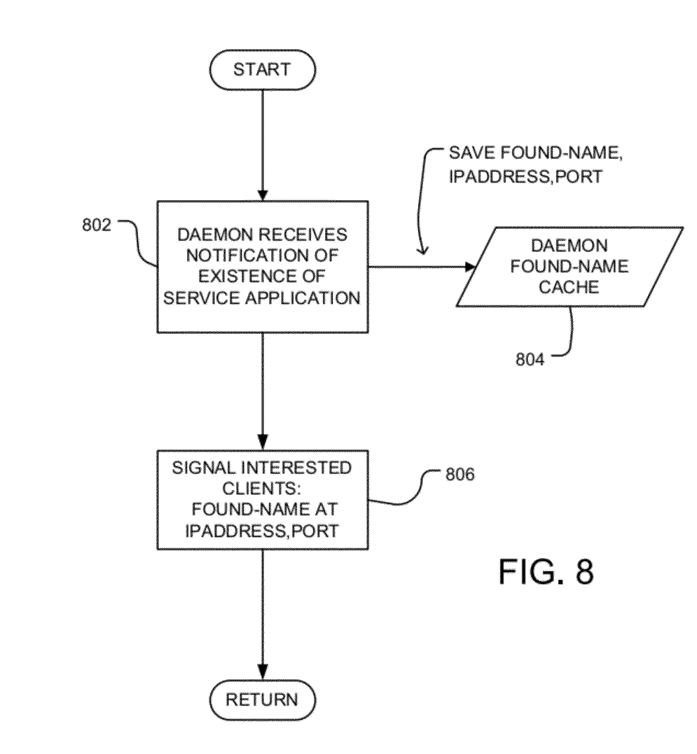

The exemplary conversation between computing systems in a multicast group, as depicted in FIG. 4 and described immediately above, is performed by bus daemons and their name service modules working together to execute the operation flows shown in FIGS. 5-8. A bus daemon in its computing system, when prompted by a request from a service application in FIG. 5 or client application in FIG. 6, acts to initiate a multicast operation from a responder in the daemon's name service module. FIG. 7 illustrates the operation flow of the responder. FIG. 8 illustrates the operation flow of a daemon in the computing system notifying its client application that a service application has been found.

The logical operations in the operation flow diagrams of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

In FIG. 5, advertise operation 502 at the bus daemon receives from a service application a request to advertise attribute information about the service application. The advertise request corresponds to discovery request 404 (FIG. 4). Advertise operation 502 saves the service application well-known-name, being advertised, in the application name cache 504 and calls the name service module 506 of the bus daemon. Name service module 506 saves the advertised well-known-name in the name service cache 508 and initiates a discovery operation request, which in this case is an ADVERTISE operation request, at multicast request operation 510. Multicast request operation 510 sends the ADVERTISE operation request to a responder module in the name service module. The responder will multicast a discovery message containing the well-known-name attribute of the service application being advertised.

In FIG. 6, FIND-NAME operation 602 at the bus daemon receives from a client application a FIND-NAME message 419 (FIG. 4) requesting the bus daemon to find a service application with a given well-known-name attribute. In one embodiment the given well-known-name attribute is the well-known-name prefix of the peer application making the discovery request. FIND-NAME operation 602 saves the client application well-known-name in the daemon's interested-client-applications name list 604 and calls the name service module 606 of the bus daemon. Name service module 606 initiates a discovery operation request, which in this case is a FIND-NAME operation request, at multicast request operation 608. Multicast request operation 608 sends a FIND-NAME operation request to a responder module in the name service. The responder will multicast a discovery message containing the well-known-name prefix attribute of the service application being sought by the client application.

FIG. 7 shows the operational flow of the responder module in the name service. The responder, like the bus daemon and name service, may come up when the computing system powers on and may stay up until the computing system powers off. Multiple responders are allowed on any given computing system. The operational flow begins at wait operation 702. Wait operation 702 is waiting for receipt of a timer event, an operation request event or a UDP packet event. Event-type test operation 704 detects the type of event received by the wait operation 702. If the event is an operation request event, the operation flow branches from event-type test operation 704 to operation-type detect module 706. If the event is a UDP packet event, the operation flow branches to message-type detect module 708. If the event is a timer event, the operation flow branches to the timer-expired detect module 710.

When the event is an operation request event, operation-type detect module 706 tests whether the operation request is a FIND-NAME operation request or an ADVERTISE operation request. If it is an ADVERTISE operation request, the operation flow branches from the operation-type detect module 706 to the IS-AT operation 712. IS-AT operation 712 formats and sends a discovery message, in this case an IS-AT message, e.g. message 408 (FIG. 4), effectively saying for its associated bus daemon, “I have <org.example.Well-Known-Name.Instance> service application.” From IS-AT operation 712, the operation flow returns to wait operation 702.

If the operation request is a FIND-NAME operation request, the operation flow branches from the operation-type detect module 706 to the WHO-HAS operation 714. WHO-HAS operation 714 formats and sends a discovery message, in this case a WHO-HAS message, e.g. message instance 420 (FIG. 4), effectively asking for a bus daemon, “Who has <org.example.Well-Known-Name.*> service application? Then the operation flow returns to wait operation 702.

When the event is receipt of a UDP Packet from a remote bus daemon, message-type detect module 708 tests whether the UDP packet is an IS-AT message or a WHO-HAS message. If the UDP packet is an IS-AT message, the operation flow branches from the message-type detect module 708 to notify-daemon operation 716. Notify operation 716 notifies the bus daemon associated. with responder that an IS-AT message for <org.example.Well-Known-Name.Instance> service application has been received, and the service application is available through a bus daemon at IPADDRESS,PORT in a remote computing system.

The IS-AT UDP packet is generated at a remote computing system as a result of either an ADVERTISE operation request at a remote bus daemon or as a result of WHO-HAS UDP packet being received at the name service of the remote bus daemon. In either case the receipt of an IS-AT message by a name service at a home bus daemon in the user's computing system is handled by the responder's notify-daemon operation 716. Notify operation 716 notifies the home bus daemon an instance of a service application with a well-known-name attribute is available for interested client applications (if any) attached to the home bus daemon. The operational flow of the bus daemon in response to the notification is shown in FIG. 8 described hereinafter. After the notify-daemon operation 716 in FIG. 7, the operational flow returns to wait operation 702.

If the UDP packet from a remote bus daemon is a WHO-HAS message the operational flow branches from message-type detect module 708 to “have-name” test operation 718. If the bus daemon does not have an instance of a service application with a well-known-name attribute as asked for in the WHO-HAS message, the operation flow branches NO from the have-name test operation 718 and returns to wait operation 702 to wait for the next event. If the bus daemon has an instance of a service application with the well-known-name attribute sought by the WHO-HAS message, the operation flow branches YES to IS-AT operation 712. IS-AT operation 712 formats and sends an IS-AT message saying the home bus daemon has an instance of the well-known-named service application. IS-AT message instance 422 (FIG. 4) is an example of an IS-AT message being returned in response to a WHO-HAS message. Note that IS-AT operation 712 will send an IS-AT message in response to an ADVERTISE operation request or an appropriate WHO-HAS packet event where the have-name test 718 is satisfied. After the IS-AT message is sent, the operation flow returns to wait operation 702.

When the event is a timer event, timer-expired detect module 710 detects whether the expired timer event was a retry timer or a keep-alive timer. If the timer event is a keep-alive timer event, the operation flow branches from timer-expired detect module 710 to keep-alive operation 720. Keep-alive operation formats and sends an IS-AT message, e.g. message instances 414, 426 and 427, for all advertised names of service applications currently being advertised by a name service for a bus daemon. Even if a bus daemon sending the IS-AT message has joined with another bus daemon as a result of an earlier discovery process, the keep-alive operation will continue to provide an opportunity for other bus daemons in the IP multicast group to join with the bus daemon. From keep-alive operation 720 the operation flow returns to wait operation 702.

If the timer event is a retry timer event, the operation flow branches from timer-expired detect module 710 to retry operation 722. Retry operation 722 resends a WHO-HAS message, e.g. messages instances 428 and 429, seeking an instance of a well-known-named service applications currently being sought by a name service for a bus daemon with a client application seeking the named service applications. Even if the bus daemon retrying the WHO-HAS message has joined, with another bus daemon as a result of an earlier discovery process, the retry operation will continue to provide an opportunity for other bus daemons in the multicast group to join with the bus daemon by retrying the WHO-HAS message. From retry operation 722. the operation flow returns to wait operation 702.

FIG. 8 illustrates the operation flow of a bus daemon in the computing system notifying its client application that an instance of a service application with a requested well-known-name attribute has been found. Notification operation 802 at the daemon receives notification from notify-daemon operation 716 in the responder of daemon's name service that the service application with the well-known-name attribute the same as the well-known-name prefix in a FIND-NAME request is available. The same-name operation 802 saves the service application's well-known-name in a found-name list in the daemon's found-name cache 804. Notification operation 802 also saves the IPADDRESS,PORT of the bus daemon where the desired service application is located. Found-name operation 806 sends a FOUND-NAME message, e.g. message instance 424 (FIG. 4), from the daemon to signal interested client applications of a found-name. The FOUND-NAME message includes the name of same named service application that has been found and the IPADDRESS,PORT of its bus daemon. This completes the discovery phase for the client application that initiated the FIND-NAME request.

Although the invention has been described in language specific to computer structural features, methodological acts and computer processes on computer readable media, it is to be understood that the invention defined in the appended claims is not necessarily limited to the specific structures, acts or media described. As an example, other logical operations may be included in the bus daemon discovery process. Also to the extent FIGS. 3 and 4 have been described as conversations between two computing systems, such conversations will typically be occurring in parallel amongst multiple computing systems in an IP multicast group. Therefore, the specific structural features, acts and media are disclosed as exemplary embodiments implementing the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the spirit and scope of the present invention, which is set forth in the following claims.

What is claimed is:

1. An apparatus for discovering client applications and service applications available for communication through daemons in computing systems in a multicast group of computing systems, the apparatus comprising:
a daemon module in a computing system in the multicast group, the daemon module in response to discovery requests from its client applications and its service applications initiating multicasts of attribute information for client applications and service applications, the attribute information for each client application and service application having at least a well-known-name attribute in the attribute information description of each application;
a name service module in the computing system associated with the daemon module and in response to a discovery request initiating a discovery operation request;
a responder module in the computing system associated with the name service module and in response to the discovery operation request sending a discovery message to the multicast group, the discovery message comprises attribute information with a given well-known-name of a client application or service application making the discovery request at the computing system;
said responder module responsive to a first type discovery message from the computing system or another computing system in the multicast group, the first type discovery message asking for any instance of a named service application with a well-known-name attribute matching that specified by a named client application making a discovery request, and if the computing system has such an instance of the named service application, said responder module sending a second type discovery message identifying the instance of the named service application with the well-known-name attribute at the computing system; and
said responder module responsive to a second type discovery message from a computing system in the multicast group, the second type discovery message announcing an instance attribute and a well-known-name attribute for a service application at the computing system in the multicast group, and said responder module notifying the daemon module of the availability of an instance of the service application with the well-known-name attribute at the computing system in the multicast group.

2. The apparatus of claim 1 wherein a discovery request is an advertise request from a service application at the computing system and wherein:
said name service module initiates an advertise operation request; and
said responder module in response to the advertise operation request sends the second type discovery message announcing a service application with a well-known-name attribute is available at the daemon module of the computing system.

3. The apparatus of claim 1 wherein the discovery request is a find-name request from a client application at the computing system and wherein:
said name service module initiates a find-name operation request; and
said responder module in response to the find-name operation request sends the first type discovery message asking who has an instance of a service application with a well-known-name attribute matching the name in the find-name request.

4. The apparatus of claim 3 wherein the attribute information in the first type discovery message comprises both the well-known-name attribute of a service application and an instance attribute identifying any instance of a service application with the well-known name attribute.

5. The apparatus of claim 1 further comprising:
said daemon module responsive to a notification from said responder module that the service application with the well-known-name attribute is available at the computing system or another computing system in the multicast group and signaling interested client applications of the daemon module that the service application is available.

6. The apparatus of claim 1 further comprising a module resending the discovery messages periodically whereby computing systems may join and leave the multicast group of computing systems that are communicating between client applications and service applications having the well-known-name attribute.

7. In a computing system, a discovery apparatus in a user's computing system for discovering service applications available for communication through a bus daemon in the user's computing system to a remote computing system of a multicast group of computing systems, said discovery apparatus comprising:
initiating means responsive to a discovery request from a service application for initiating an advertise operation request from the bus daemon in the user's computing system;
multicasting means responsive to the advertise operation request for multicasting an announce message to the multicast group of computing systems, the announce message having attribute information with a well-known-name and an instance identifier of the service application and an address of the bus daemon in the user's computing system through which the service application is available; and
notifying means responsive to an announce message from a remote computing system for notifying the bus daemon in the user's computing system of the availability of a service application having a well-known-name attribute and an instance identifier at a remote bus daemon in the remote computing system.

8. The discovery apparatus of claim 7 further comprising:
said initiating means responsive to a discovery request from a client application for initiating an find-name operation request from the bus daemon in the computing system;
said multicasting means responsive to the find-name operation request for multicasting a query message to the multicast group of computing systems, the query message asking if any instance of a service application with the well-known-name attribute is available at any computing system in the multicast group of computing systems; and
announce means responsive to a query message from a remote computing system in the multicast group for sending an announce message from the bus daemon in the user's computing system if the user's computing system has an instance of the service application with the well-known-name attribute, the announce message comprising attribute information identifying an instance of the service application with the well-known-name attribute and an address of the bus daemon at the user's computing system.

9. The discovery apparatus of claim 8 farther comprising:
means for resending periodically a multicast of the announce message with attribute information for all instances of service applications being advertised from the user's computing system whereby instances of service applications may join or leave participation in communication with client applications in computing systems performing operations with applications having the well-known-name attribute.

10. The discovery apparatus of claim 9 further comprising:
means for resending periodically a multicast of a query message with well-known-name attributes of all interested client applications at the bus daemon in the user's computing system whereby instances of service applications may join or leave participation in communication with client applications in computing systems performing operations with applications having the well-known-name attribute.

11. In a user's computing system, a discovery method for discovering client applications and service applications available for communication through a home bus daemon in the user's computing system or through the home bus daemon and a remote bus daemon in a remote computing system of a multicast group of computing systems, the discovery method comprising:
initiating an advertise operation request from the home bus daemon in response to a discovery request from a service application available at the home bus daemon;
in response to an advertise operation request, multicasting an advertise message to the multicast group of computing systems, the advertise message comprises attribute information with an instance identifier and well-known-name attribute of the service application at the user's computing system and an address of the home bus daemon through which the service application is available; and
in response to an advertise message from a remote bus daemon, notifying the home bus daemon of the availability of an instance of a service application with the well-known-name attribute at the remote bus daemon.

12. The discovery method of claim 11 further comprising:
initiating a find-name operation request from the home bus daemon in response to a discovery request from a client application at the user's computing system;
in response to a find-name operation request, multicasting a query message to the multicast group of computing systems from the home bus daemon, the query message asking for a service application based only on well-known-name attribute that matches the well-known-name requested by the client application; and
in response to a query message, detecting whether the home bus daemon has the service application with the well-known-name matching the attribute in the query message and sending an advertise message if an instance of the service application with the well-known-name attribute is available through the home bus daemon at the user's computing system.

13. The discovery method of claim 12 further comprising:
sending periodically a multicast of an advertise message with attribute information describing all instances of service applications having well-known-name attributes advertised from the home bus daemon whereby instances of service applications may join or leave participation in communication with client applications in computing systems performing operations with applications having the well-known-name attribute.

14. The discovery method of claim 12 wherein the said multicasting multicasts a query message asking for any instance of a service application with the well-known-name attribute that matches the name requested by the client application and irrespective of the service application's instance identifier.

15. A computer program product readable by a computing system and encoding a computer program of instructions for executing a computer process for resolving attribute information of service applications to enable communications between the service applications and client applications in computing systems in a multicast group of computing systems, said computer process comprising:
initiating an advertise operation request from a bus daemon in response to a advertise request from an instance of a service application with a well-known-name attribute;
in response to an advertise operation request, multicasting IS-AT message to the multicast group of computing systems, the IS-AT message having attribute information comprising at least a well-known-name attribute and an instance identifier for the service application and an address for the bus daemon through which the service application is available; and
initiating a find-name operation request from the bus daemon in response to a find-name request from a client application for a service application matching a given well-known-name attribute;
in response to the find-name request, multicasting a WHO-HAS message to the multicast group of computing systems from the bus daemon, the WHO-HAS message comprises attribute information for an instance of a service application matching the well-known-name attribute provided by the client application; and
in response to the WHO-HAS message multicasting IS-AT message if the bus daemon has an instance of the service application with the well-known-name attribute, the IS-AT message comprising attribute information describing an instance of a service application matching the well-known-name attribute specified by the client application and an address of the bus daemon through which the service application is available.

16. The computer process of the computer program product of claim 15 wherein said multicasting IS-AT message in response to a WHO-HAS message further comprises:
detecting whether the bus daemon has the instance of the service application with the well-known-name attribute that matches the name specified by the client application.

17. The computer process of the compute program product of claim 15 further comprising:
resending periodically a multicast of an IS-AT message with all instances of all service applications with a well-known-name attribute that have been advertised from the bus daemon whereby service applications and client applications may join or leave an instance of a application at will.

18. The computer process of the computer program product of claim 15 wherein:
in response to a notification of the service application with the well-known-name attribute available through a bus daemon, storing the well-known-name for the service application in a found-name list along with an address for the bus daemon.
